(19) United States
(12) Patent Application Publication
(10) Pub. No.: US 2025/0319626 A1
(43) Pub. Date: Oct. 16, 2025

(54) WOOD SPLITTING APPARATUS

(71) Applicant: M.J. Huner LLC, Summit, IL (US)

(72) Inventor: Mitchell Huner, Summit, IL (US)

(73) Assignee: M.J. Huner LLC, Summit, IL (US)

(21) Appl. No.: 18/633,701

(22) Filed: Apr. 12, 2024

(51) Int. Cl. B27L 7/00; B27L 7/06

(52) U.S. Cl. CPC B27L 7/005; B27L 7/06

(57) ABSTRACT

A wood splitting apparatus that includes a head having a fore portion, a mid portion, a transition portion, and an aft portion. The transition portion forms a first pair of planar glancing surfaces between the fore portion and the mid portion. The fore portion includes a splitting wedge having a back end and including a longitudinal arcuate striking face. The longitudinal arcuate striking face at its apex includes a piercing edge tapering into a splitting edge. A longitudinal journal formed in the mid portion to receive a handle. Material in an object impacted by the fore portion is split by the splitting wedge and directed away from the stem portion and into the second pair of glancing surfaces and around the mid portion.

### BACKGROUND OF THE INVENTION

### Field of the Invention

This invention generally relates to striking tools and, particularly, to wood splitting apparatus and methods of using the wood splitting apparatus for splitting objects.

### Description of Problems with the Prior Art

Axes, sledgehammers, mattocks, and other striking tools are well known in the art. Generally, these striking tools include a sharp, wedge-shaped metal head mounted to a sturdy wooden or composite handle. The head is configured to perform a specific function, for example, efficiently and safely splitting large pieces of wood into smaller, manageable sections. These striking tools can be operated by a user by angularly accelerating the head while gripping the handle, the head being directed toward a target object, for example, a wood log. The inherent mechanical function of such striking tools relies on them impacting the target object with a significant and sufficient force.

The conventional striking tools, especially those meant for splitting wood, may suffer from certain challenges. For example, the striking tool may get stuck in the wood, especially if the head is not properly shaped or if the wood has knots. This can make it challenging to remove the axe and continue splitting. Also, inefficient splitting can occur if the striking tool is not suited for the type or size of wood being split. Using a striking tool with wrong weight or head design may make the process more difficult and time-consuming.

Therefore, there is a need for striking tools which can overcome the above challenges. In particular, there is a need for striking tools which minimize the chances of getting stuck in the wood while carrying out a splitting operation and possess the right splitting mechanism that allows for efficiently performing the wood splitting operation.

### BRIEF SUMMARY OF THE INVENTION

This summary is provided to introduce a selection of concepts, in a simplified format, that are further described in the detailed description of the invention. This summary is neither intended to identify key or essential inventive concepts of the invention and nor is it intended for determining the scope of the invention.

In an embodiment, a wood splitting apparatus is disclosed. The wood splitting apparatus may include a head that may further include a fore portion, a mid portion, a transition portion 106 between the fore portion 102 and the mid portion 104, and an aft portion 108. The transition portion may form a first pair of planar glancing surfaces between the fore portion and the mid portion. The transition portion may further form a second pair of planar glancing surfaces between the first pair of glancing surfaces and the mid portion. The head may further include a longitudinal journal formed in the mid portion and adapted to receive a handle. The fore portion 102 may include a splitting wedge having a back end. The splitting wedge may include a longitudinal arcuate striking face opposite the back end. The longitudinal arcuate striking face, at its apex, may include a piercing edge located substantially towards the top of the longitudinal arcuate striking face. The piercing edge may taper into a splitting edge in both directions along the longitudinal arcuate striking face.

The fore portion may further include a stem portion extending from the back end to the transition portion. The width of the stem portion may be substantially less than the width of the back end. The splitting wedge may have a planar left face and a right face. In an example embodiment, an angle between the left face and the right face at the splitting edge may be between 18 and 22 degrees. The plane of substantially the top of each of the left face and right face may be obliquely incident to each of the second pair of planar glancing surfaces. During operation of the wood splitting apparatus, material in an object impacted by the fore portion may be split by the splitting wedge and directed away from the stem portion and into the second pair of glancing surfaces and around the mid portion. The wood splitting apparatus may include a handle secured within the longitudinal journal.

It is an object of the invention to provide a wood spitting apparatus free from the limitations of standard axe-type and striking tools. It is another object of the invention to provide striking tools that minimize the chances of the striking tool getting stuck in the wood while carrying out splitting operation and possess the right weight and construction that allows for efficiently performing the wood splitting operation. It is yet another objective of the invention to teach a method of using a wood spitting apparatus, as described herein, wood splitting procedures as may be used in wood cutting operations. It is another object of the invention to teach a method of using a wood spitting apparatus, as described herein, along with a wedge using the blunt side of the head of the wood spitting apparatus for performing wood splitting procedures. Further objects and features of this invention will become more apparent upon considering the following drawings and description.

To further clarify the advantages and features of the present invention, a more particular description of the invention will be rendered by reference to specific implementations thereof, which is illustrated in the appended drawings. It is appreciated that these drawings depict only typical implementations of the invention and are therefore not to be considered limiting of its scope. The invention will be described and explained with additional specificity and detail with the accompanying drawings.

These and other features, aspects, and advantages of the present invention will become better understood when the following detailed description is read with reference to the accompanying drawings in which like characters represent like parts throughout the drawings.

### BRIEF DESCRIPTION OF THE DRAWINGS

The accompanying figures and drawings, incorporated into and forming part of the specification, service to further illustrate the present invention, its various principles and advantages, and its varying embodiments:

FIG. 1A illustrates a top isometric view of a head of an exemplary wood splitting apparatus, in accordance with an embodiment of the present disclosure. FIG. 1B illustrates a bottom isometric view of a head of an exemplary wood splitting apparatus, in accordance with an embodiment of the present disclosure.

FIG. 2 illustrates a top view of the head of FIGS. 1A, 1B, in accordance with an embodiment.

FIGS. 3, 4A, 4B illustrate a wood splitting apparatus in a method of splitting an object, in accordance with some embodiments.

FIG. 5 illustrates the wood splitting apparatus in a method of splitting an object using a wedge, in accordance with some embodiments.

### DETAILED DESCRIPTION OF THE INVENTION

A wood splitting apparatus is disclosed that may include a head and a handle. The head may be made from a metal or an alloy having sufficient strength and hardness to endure the impact when the head is struck against an object (for example, wood log) to be split. The head may define a fore portion, the mid portion, an aft portion, and a transition portion between the fore portion and the mid portion. A longitudinal journal may be formed in the mid portion of the head that may be adapted to receive the handle. As will be appreciated by those skilled in the art, the handle may be manufactured from wood or a composite material having impact absorbing capability, to prevent transferring of the impact to a user gripping the handle while impacting the object. The transition portion may form a first pair of planar glancing surfaces between the fore portion and the mid portion and a second pair of planar glancing surfaces between the first pair of glancing surfaces and the mid portion.

The fore portion of the head may include a splitting wedge which may define a back end and a longitudinal arcuate striking face opposite the back end. The longitudinal arcuate striking face, at its apex, may include a piercing edge which may be located substantially towards the top of the longitudinal arcuate striking face. The piercing edge may taper into a splitting edge in both directions along the longitudinal arcuate striking face.

The fore portion of the head may also include a stem portion extending from the back end to the transition portion, such that the width of the stem portion is substantially less than the width of the back end. In other words, the thickness of the head around the stem portion is lesser than the thickness of the splitting wedge at the back end and the thickness of the head around the transition portion. The splitting wedge may have a planar left face and a right face aligned at an angle to each other. This an angle between the left face and the right face at the splitting edge may be between 18 and 22 degrees. The plane of substantially the top of each of the left face and right face may be being obliquely incident to each of the second pair of planar glancing surfaces.

During use, the material in the object impacted by the fore portion may be split by the splitting wedge and directed away from the stem portion and into the second pair of glancing surfaces and around the mid portion. In other words, the wood splitting apparatus may be impacted on the object with the piercing edge first contacting the object. To this end, the piercing edge may have a sharp pointed edge that may pierce into the object and initiate the splitting of the object. As the head travels into the object during splitting, the head may travel past the object, the splitting edge (in both directions along the longitudinal arcuate striking face) may cause the split portions of the object to move away from each other. As the head further travels into the object, the split portions of the object may be further directed away by the second pair of planar glancing surfaces.

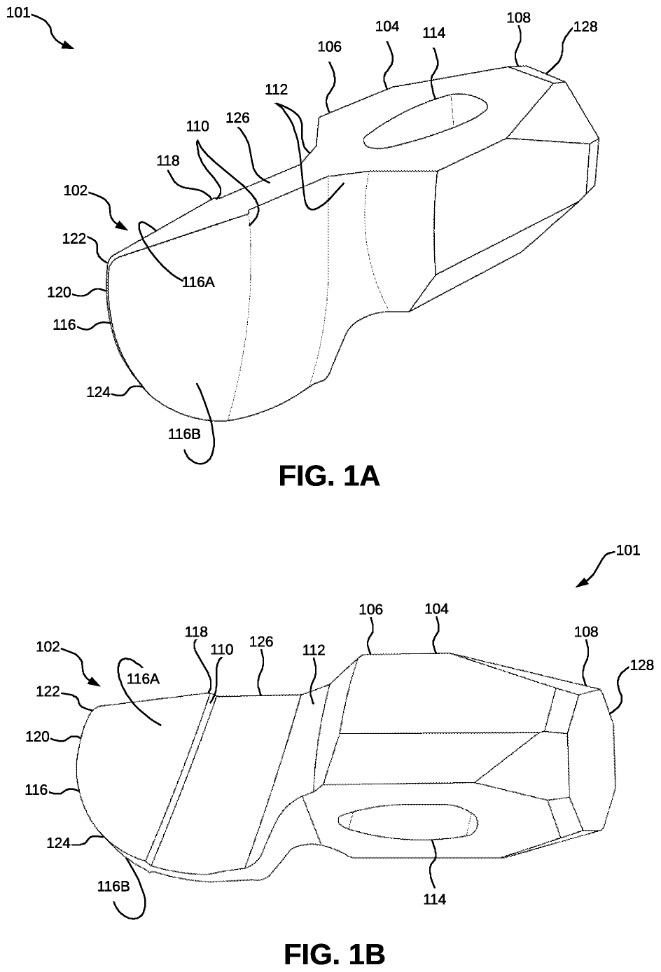

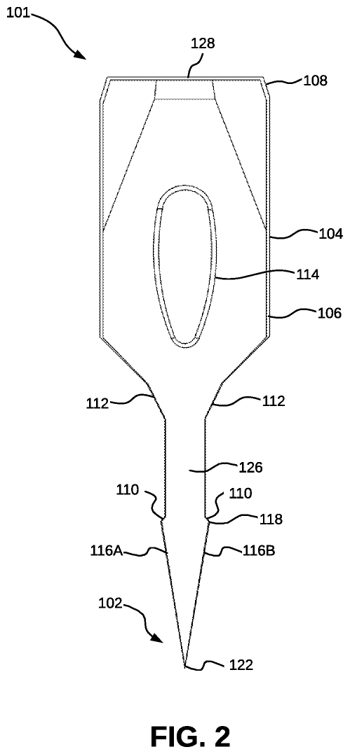

Referring to FIGS. 1A-1B and 2, a first and second perspective view and a top view, respectively, of a head 101 of a wood splitting apparatus are illustrated, in accordance with an embodiment of the present disclosure. The head 101 of the wood splitting apparatus, as illustrated herein, may be made from any material suitable for striking and splitting purposes which generally include durable metal alloys (e.g., rolled steel and titanium alloys). The head 101 may include a fore portion 102, a mid portion 104, and an aft portion 108. As illustrated in FIGS. 1A-1B and 2, the fore portion 102 may be located towards the front of the head 101, the aft portion 108 towards the rear of the head 101, and the mid portion 104 between the fore portion 102 and the aft portion 108. The head 101 may further include a transition portion 106 that may be positioned between the fore portion 102 and the mid portion 104.

In an embodiment, the transition portion 106 may form a first pair of planar glancing surfaces 110 between the fore portion 102 and the mid portion 104. In particular, as shown in FIG. 2, the first pair of planar glancing surfaces 110 may include a left planar glancing surface 110A and a right planar glancing surface 110B. In other words, the left planar glancing surface 110A and the right planar glancing surface 110B may be formed on a left side and a right side of the transition portion 106, and separated by a stem portion 126. Each of the left planar glancing surface 110A and the right planar glancing surface 110B may be inclined at a first angle to left and right planes associated with the stem portion 126, respectively.

Beside the first pair of planar glancing surfaces 110, the transition portion 106 may form a second pair of planar glancing surfaces 112 positioned between the first pair of glancing surfaces 110 and the mid portion 104. In particular, as shown in FIG. 2, the second pair of planar glancing surfaces 112 may include a left planar glancing surface 112A and a right planar glancing surface 112B. The left planar glancing surface 112A and the right planar glancing surface 112B may be formed on the left side and the right side of the transition portion 106, and separated by a stem portion 126. Each of the left planar glancing surface 112A and the right planar glancing surface 112B may be inclined at a second angle to the left and right planes associated with the stem portion 126, respectively. In an embodiment, the thickness of the stem portion 126 may be consistent throughout the length of the stem portion 126, i.e. between the first pair of planar glancing surfaces 110 and the second pair of planar glancing surfaces 112.

The head 101 may further include a longitudinal journal 114 formed in the mid portion 104 that may be adapted to receive a handle 103. The longitudinal journal 114 may extend through the mid portion 104 of the head 101. In an example embodiment, the longitudinal journal 114 may have an ovular cross-section, to aid in fixing of the handle within the longitudinal journal 114. As will be appreciated, the handle may be press-fit inside the longitudinal journal 114, for example, with a wooden wedge.

As mentioned above, the fore portion 102 may include the stem portion 126 extending from the back end 118 to the transition portion 106. In an embodiment, the width of the stem portion 126 may be substantially less than the width of the back end 118.

In an embodiment, the fore portion 102 may include a splitting wedge 116 having a back end 118. The splitting wedge 116 may include a longitudinal arcuate striking face 120 opposite the back end 118. The longitudinal arcuate striking face 120, at its apex, may further define a piercing edge 122 that may be located substantially towards the top of the longitudinal arcuate striking face 120, as illustrated in FIGS. 1A-1B. Further, as can be seen in FIG. 1B, the piercing edge 122 may taper into a splitting edge 124 in both directions along the longitudinal arcuate striking face 120. The splitting wedge 116 may have a planar left face 116A and a right face 116B. In an embodiment, an angle between the left face 116A and the right face 116B at the splitting edge 124 may lie in a range between 18 and 22 degrees. The plane of substantially the top of each of the left face 116A and right face 116B may be obliquely incident to each of the second pair of planar glancing surfaces 112 (i.e. the left first planar glancing surface 112A and the right first planar glancing surface 112B).

During use, the material in the object impacted by the fore portion 102 may be split by the splitting wedge 116 and directed away from the stem portion 126 and into the second pair of glancing surfaces 112 and around the mid portion 14. In other words, the head 101 of the wood splitting apparatus may be impacted on the object with the piercing edge 122 first contacting the object. To this end, the piercing edge 122 may have a sharp pointed edge that may pierce into the object and initiate the splitting of the object. As the head 101 travels into the object during splitting, the splitting edge 124 (in both directions along the longitudinal arcuate striking face 124) may cause the object to begin to split. As the head 101 further continues to travel into the object, split portions of the object may be directed away by the second pair of planar glancing surfaces 112.

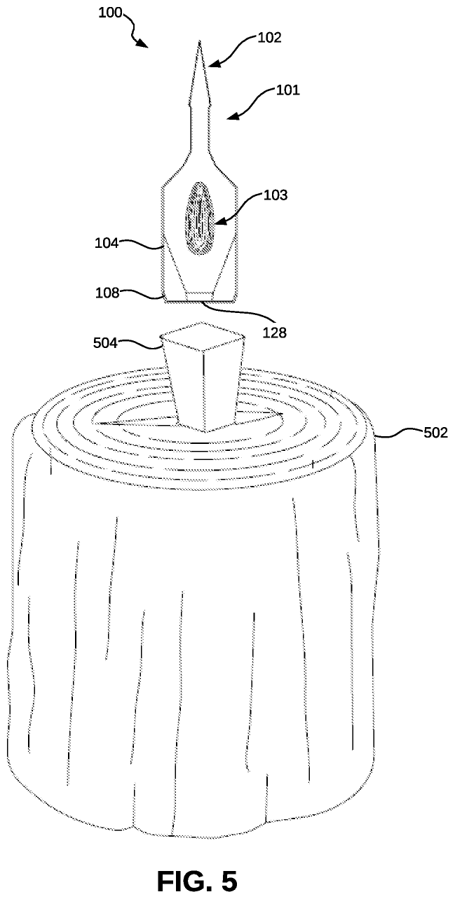

The head 101 may further include a maul 128 positioned towards the rear of the head 101. In particular, the aft portion 108 of the head 101 may define the maul 128. As can be seen in FIGS. 1A-1B, the maul 128 does not include any sharp or piercing edge, but may include a flat or a rounded surface that can be used for performing various activities. For example, the maul 128 may be used for driving a wedge in a wood log, as is shown in and explained in conjunction with FIG. 5.

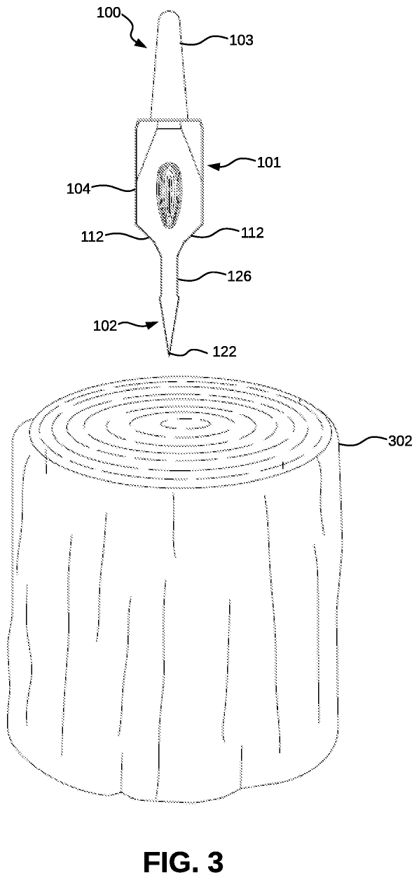

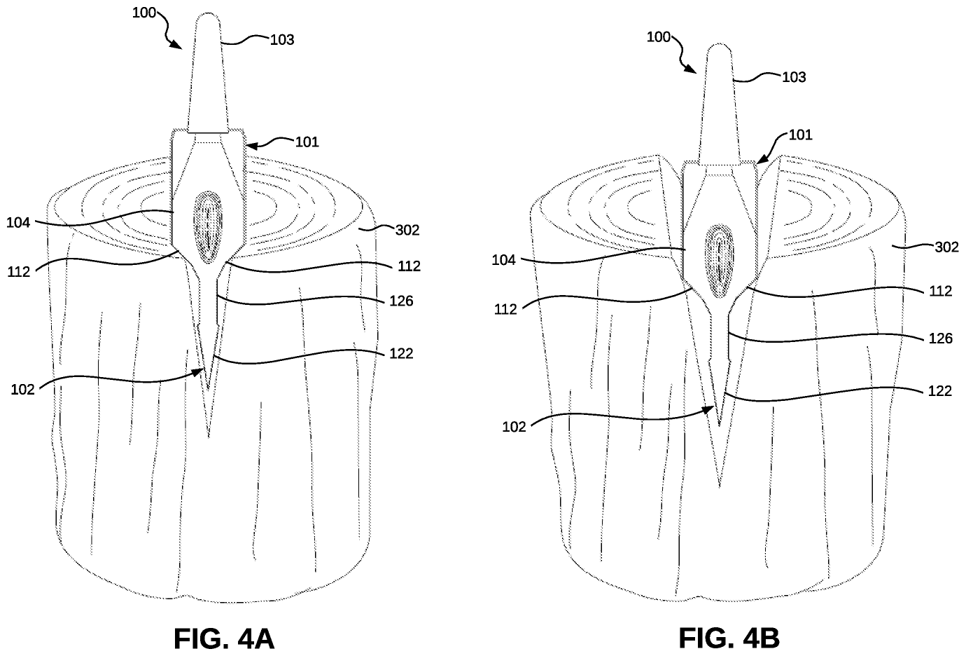

Referring now to FIGS. 3, 4A, and 4B, a wood splitting apparatus 100 is illustrated in methods of splitting an object 302, in accordance with some embodiments. For example, the object 302 may be a wood log (therefore, the terms “object” and “wood log” may have been used interchangeably in this disclosure). The wood splitting apparatus 100 may include the head 101 and a handle 103, as described above. The handle 103 may generally be made from wood, fiberglass, laminated carbon fiber, or other materials which are shock resistant and/or have vibration-dampening characteristics. The handle may be secured within the longitudinal journal 114 of the head 101 by adhesive and/or collared means (for example, as described in U.S. patent application Ser. No. 15/016,240).

As illustrated in FIG. 3, in order to perform splitting of the wood log 302, the wood splitting apparatus 100 may be oriented in a way such that the fore portion 102 of the head 101 of the wood splitting apparatus 100 is facing towards the wood log 302. Further, it should be noted that ideally the head 101 of the wood splitting apparatus may be impacted on the wood log 302 with the piercing edge 122 first contacting the wood log 302. As mentioned above, the piercing edge 122 may have a sharp pointed edge that may pierce into the wood log 302 to initiate the splitting of the wood log 302.

As illustrated in FIG. 4A, once the head 101 is just pierced into the wood log 302, the splitting edge 124 (in both directions along the longitudinal arcuate striking face 124) may cause wood log 302 to begin to split.

Further, as illustrated in FIG. 4B, as the head 101 further travels into the wood log 302, the fore portion 102 of the head 101 moves past split portions of the wood log 302, and thereafter, the split portions of the wood log 302 are directed away by the second pair of planar glancing surfaces 112. The material in the wood log 302 impacted by the fore portion 102 of the head 101 may be split by the splitting wedge 116 (not shown in FIG. 4) and directed away from the stem portion 126 and into the second pair of glancing surfaces 112 and around the mid portion 104 of the head 101. As will be understood, multiple impacts (blows) of the fore portion 102 of the head 101 may be provided on the wood log 302 for completely splitting the wood log 302 into two or more split pieces.

Referring now to FIG. 5, the wood splitting apparatus 100 is illustrated in a method of splitting an object 502 using a wedge 504, in accordance with some embodiments. For example, the object 502 may be a wood log (the terms “object” and “wood log” may have been used interchangeably in this disclosure). As described above, the wood splitting apparatus 100 may include the head 101 and the handle 103. As illustrated in FIG. 5, in order to perform the action of splitting the wood log 502, the wedge 504 may be positioned on the object 502. The wood splitting apparatus 100 may be oriented in a way such that the aft portion 108 of the head 101 of the wood splitting apparatus 100 faces towards the wood log 502. The head 101 includes the maul 128 positioned at the aft portion 108. As illustrated in FIG. 5, the maul 128 does not include any sharp or piercing edge, but may include a flat or a rounded surface.

During the operation of splitting of the wood log 502, the wedge 504 may be inserted into a crevice formed on the wood log 502. By way of an example, the crevice may be formed by striking the wedge 504 with the wood log 502, or by striking the fore portion 102 of the wood splitting apparatus 100 on the wood log 502. In some scenarios, the crevice may even be naturally present on the wood log 502. The wood log 502 may be split by driving the wedge 504 further into the crevice. To this end, once the wedge 504 is initially inserted into the crevice, the maul 128 may be used for driving the wedge 504 further inside the wood log 502, as is shown in FIG. 5. The maul 128 of the wood splitting apparatus 100 may be impacted on wedge 504. The rounded or flat surface of the maul 128 may be capable of delivering powerful blows to the wedge 504, thereby making it more suitable for driving the wedge and splitting the wood log 502. As the wedge 504 is driven inside the wood log 502 by impacting with the maul 128, the wood log 502 may cause splitting of the wood log 502. As will be understood, multiple impacts (blows) of the maul 128 on the wedge 504 may be provided for completely splitting the wood log 502 into two or more split pieces.

Skilled artisans will appreciate that elements in the drawings are illustrated for simplicity and may not have necessarily been drawn to scale. For example, in terms of the construction of the apparatus, one or more components of the device may have been represented in the drawings by conventional symbols, and the drawings may show only those specific details that are pertinent to understanding the implementations of the present invention so as not to obscure the drawings with details that will be readily apparent to those of ordinary skill in the art having benefit of the description herein.

For the purpose of promoting an understanding of the principles of the invention, reference will now be made to the implementation illustrated in the drawings and specific language will be used to describe the same. It will nevertheless be understood that no limitation of the scope of the invention is thereby intended, such alterations and further modifications in the illustrated apparatus, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The apparatus, methods, and examples provided herein are illustrative only and not intended to be limiting.

Unless otherwise defined, all terms and especially any technical and/or scientific terms, used herein may be taken to have the same meaning as commonly understood by a person ordinarily skilled in the art.

Reference is made herein to some “implementations.” It should be understood that an implementation is an example of a possible implementation of any features and/or elements of the present disclosure. Some implementations have been described for the purpose of explaining one or more of the potential ways in which the specific features and/or elements of the proposed disclosure fulfil the requirements of uniqueness, utility, and non-obviousness.

Unless otherwise specified, one or more particular features and/or elements described in connection with one or more implementations may be found in one implementation, or may be found in more than one implementation, or may be found in all implementations, or may be found in no implementations. Although one or more features and/or elements may be described herein in the context of only a single implementation, or in the context of more than one implementation, or in the context of all implementations, the features and/or elements may instead be provided separately or in any appropriate combination or not at all. Conversely, any features and/or elements described in the context of separate implementations may alternatively be realized as existing together in the context of a single implementation. Any particular and all details set forth herein are used in the context of some implementations and therefore should not necessarily be taken as limiting factors to the proposed disclosure.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of implementations. Those skilled in the art will appreciate that one or more of the described elements may well be combined into a single functional element. Alternatively, certain elements may be split into multiple functional elements. Elements from one implementation may be added to another implementation.

What is claimed is:

1. A wood splitting apparatus comprising:
a head comprising:
a fore portion,
a mid portion,
a transition portion between the fore portion and the mid portion, and
an aft portion, and
the transition portion forming a first pair of planar glancing surfaces between the fore portion and the mid portion,
the transition portion further forming a second pair of planar glancing surfaces between the first pair of glancing surfaces and the mid portion,
a longitudinal journal formed in the mid portion adapted to receive a handle;
the fore portion comprising:
a splitting wedge,
the splitting wedge having a back end, the splitting wedge comprising:
a longitudinal arcuate striking face opposite the back end,
the longitudinal arcuate striking face at its apex comprising a piercing edge located substantially towards the top of the longitudinal arcuate striking face,
the piercing edge tapering into a splitting edge in both directions along the longitudinal arcuate striking face,
the fore portion further comprising:
a stem portion extending from the back end to the transition portion,
the width of the stem portion being substantially less than the width of the back end,
the splitting wedge having a planar left face and a right face,
the plane of substantially the top of each of the left face and right face being obliquely incident to each of the second pair of planar glancing surfaces,
wherein material in an object impacted by the fore portion is split by the splitting wedge and directed away from the stem portion and into the second pair of glancing surfaces and around the mid portion; and
a handle secured within the longitudinal journal.

2. The splitting apparatus of claim 1, wherein the aft portion comprises a maul.

3. The splitting apparatus of claim 1, wherein the angle between the left face and the right face at the splitting edge is selected from a range between 18 and 22 degrees.

4. A method of splitting wood comprising the steps of:
providing a wood splitting apparatus comprising:
a head comprising:
a fore portion,
a mid portion,
a transition portion between the fore portion and the mid portion, and
an aft portion, and
the transition portion forming a first pair of planar glancing surfaces between the fore portion and the mid portion,
the transition portion further forming a second pair of planar glancing surfaces between the first pair of glancing surfaces and the mid portion,
a longitudinal journal formed in the mid portion adapted to receive a handle;
the fore portion comprising:
a splitting wedge,
the splitting wedge having a back end, the splitting wedge comprising:
a longitudinal arcuate striking face opposite the back end,
the longitudinal arcuate striking face at its apex comprising a piercing edge located substantially towards the top of the longitudinal arcuate striking face,
the piercing edge tapering into a splitting edge in both directions along the longitudinal arcuate striking face,
the fore portion further comprising:
a stem portion extending from the back end to the transition portion,
the width of the stem portion being substantially less than the width of the back end,
the splitting wedge having a planar left face and a right face,
the plane of substantially the top of each of the left face and right face being obliquely incident to each of the second pair of planar glancing surfaces,
wherein material in an object impacted by the fore portion is split by the splitting wedge and directed away from the stem portion and into the second pair of glancing surfaces and around the mid portion; and
a handle secured within the longitudinal journal;
providing an object to be split;
introducing the piercing edge to a top of the object;
causing the piercing edge to impact the top of the object; and
causing the piercing edge to thrust into the object to cause material in the object impacted by the fore portion to be split by the splitting wedge and directed away from the stem and into the second pair of glancing surfaces and around the mid portion.

5. The method of claim 4, wherein the aft portion comprises a maul.

6. The method of claim 4, wherein the angle between the left face and the right face at the splitting edge is selected from a range between 18 and 22 degrees.

7. A method of splitting wood comprising the steps of:
providing a wood splitting apparatus comprising:
a head comprising:
a fore portion,
a mid portion,
a transition portion between the fore portion and the mid portion, and
an aft portion comprising a maul,
the transition portion forming a first pair of planar glancing surfaces between the fore portion and the mid portion,
the transition portion further forming a second pair of planar glancing surfaces between the first pair of glancing surfaces and the mid portion,
a longitudinal journal formed in the mid portion adapted to receive a handle;
the fore portion comprising:
a splitting wedge,
the splitting wedge having a back end, the splitting wedge comprising:
a longitudinal arcuate striking face opposite the back end,
the longitudinal arcuate striking face at its apex comprising a piercing edge located substantially towards the top of the longitudinal arcuate striking face,
the piercing edge tapering into a splitting edge in both directions along the longitudinal arcuate striking face,
the fore portion further comprising:
a stem portion extending from the back end to the transition portion,
the width of the stem portion being substantially less than the width of the back end,
the splitting wedge having a planar left face and a right face,
the plane of substantially the top of each of the left face and right face being obliquely incident to each of the second pair of planar glancing surfaces,
wherein material in an object impacted by the fore portion is split by the splitting wedge and directed away from the stem portion and into the second pair of glancing surfaces and around the mid portion; and
a handle secured within the longitudinal journal;
providing an object to be split;
providing a wedge into a crevice formed on the object;
impacting the maul of the head of the wood splitting apparatus on the wedge to drive the wedge further inside the object and split the object.

8. The method of claim 7, wherein the angle between the left face and the right face at the splitting edge is selected from a range between 18 and 22 degrees.
